(19) United States
(12) Patent Application Publication
(10) Pub. No.: US 2008/0137565 A1
(43) Pub. Date: Jun. 12, 2008

(54) Hybrid Wi-Fi Network for Wireless City Applications

(76) Inventors: Michael Chen, Palos Verses Estates, CA (US); Sheng-Yaw Lin, Taipei (TW); Arthur Chung-shu Jen, Hsin-Chu (TW)

Correspondence Address: LAW OFFICES OF LAI AND ASSOCIATES, P.C., 5800 RANCHESTER STE 200, HOUSTON, TX, 77036, US

(21) Appl. No.: 11/609,015

(22) Filed: Dec. 11, 2006

(51) Int. Cl. H04B 7/00

(52) U.S. Cl. 370/310

(57) ABSTRACT

This invention provides a hybrid Wi-Fi system, which consists of an regular Wi-Fi Internet Data system for data service and a special ASWT Wi-Fi VoIP network for voice service. These two systems are combined together through a special arrangement and quality of service (QoS) control to separate and adapt these two services thereby providing the best quality.

### BACKGROUND OF THE INVENTION

1. Field of the Invention

The invention pertains to the field of Wi-Fi networks. More particularly, the invention pertains to A Hybrid Wi-Fi Network for Wireless City Applications.

2. Description of Related Art

Wi-Fi Networks are known. Wi-Fi was originally developed for use in mobile computing devices, such as laptops, in LANs. But currently Wi-Fi is increasingly used in differently applications other than laptop such as Internet and VoIP phone access, gaming, and basic connectivity of consumer electronics such as televisions and DVD players, or digital cameras.

Voice data such as packetized Voice over Internet protocol (VoIP) are known to be used in a switchable way with a device such a cell phone using conventional cellular transmissions. U.S. Pat. No. 7,099,309 to Davidson entitled USING A HANDHELD COMMUNICATION DEVICE WITH A HOT SPOT NETWORK discloses a mobile unit (e.g., phone) for wireless communication that includes an antenna for detecting wireless fidelity (Wi-Fi) signals from a local area network and logic for switching the unit's operation from conventional cellular transmissions to Wi-Fi transmissions (i.e. 802.11) upon detection of Wi-Fi signals. The handheld device can communicate with a Public Switched Telephone Network (PSTN) using Voice over Internet Protocol VoIP. In one embodiment, the logic for performing the switch to Wi-Fi transmission is programmed into a subscriber identity module (SIM) card in the device and can perform the switch automatically or in response to manual input after prompting the user. Memory and code in the mobile unit measure and store the duration of both cellular and Wi-Fi transmissions by the mobile unit.

Wi-Fi networks receiving voice data from a wide area network (WAN) is know. United States Published Patent Application No. 20060046714 by Kalavade entitled MOBILE SERVICES CONTROL PLATFORM PROVIDING A CONVERGED VOICE SERVICE discloses a mobile services control platform that supports an enhanced service, Voice Forwarding to Wi-Fi or Wi-Fi Voice. Functionally, the service allows a subscriber to use a Wi-Fi device to receive voice calls directed to his or her mobile number. In a representative example, when the user connects over a Wi-Fi network, e.g., using his or her laptop or other such device, he or she selects “Wi-Fi Voice” option from a client. As a result, future voice calls directed to the user's mobile number get routed to his or her laptop over Wi-Fi, without the caller being aware that the user has connected over a different network. Similarly, voice calls made by the user from his or her laptop Wi-Fi (e.g., through a softphone) are delivered to the recipient's device as if they originated from the mobile phone number.

Priority setting for Internet data and voice data within a base station using a MAC device is known. United States Published Patent Application No. 20060098626 by Park entitled MEDIA ACCESS CONTROL DEVICE GUARANTEEING OMMUNICATION QUALITY IN WIRELESS LAN FOR VOIP discloses a MAC device that guarantees QoS in a VoIP wireless LAN by giving higher priority to voice data than to non-voice data. Transmission data generated by an application program is provided to a modem according to the priority assigned to the data. A kernel classifies the transmission data into voice and non-voice data. A MAC driver stores the voice and non-voice data in two queues, and transmits a MAC header to a MAC transmitter to notify it of generation of the transmission data, and transmits the stored voice or non-voice data to the MAC transmitter according to the type of a transmission interrupt received from the MAC transmitter in response to the notification. The MAC transmitter combines the voice or non-voice data, received from the MAC driver in response to the transmission interrupt, with a corresponding header, and outputs it to the modem. As can be seen, this Published Patent Application is to set the priority for Internet data and voice data in base station by a MAC device. This is what currently most operator is trying to do. It is showing in current market that this approach is not good, because a public network is complex in that the volume of ration between voice and data packets may change rapidly without a predictable pattern. Therefore, the simple priority setting pattern of Application No. 20060098626 is not sufficient for a single base station or router in handling this complexity.

Current WiFi Wireless City infrastructure typically is originally designed for Internet Data service. In this typically current infrastructure, WiFi IP Phone for voice service has QoS problems in that the requirements for Internet data service and VoIP voice services are totally different. In fact, these two services compete against at each other. In addition, existing standards such as 802.11 including the future 802.11.e provides only limited QoS to separate these two services. Therefore, for large-scale operation such as wireless city or public network operators, desired voice quality cannot be provided using a known WiFi network. Typically, Internet Data services require wide-bandwidth. Further Internet Data service allows for time sharing and re-transmiting for byte-error. In Internet Data services, real-time requirement is secondary. Whereas, on the other hand, VoIP voice service requires much less bandwidth but more stringent real time requirement typically is associated with the major quality problems such as in current WiFi Wireless City operation.

Virtually all Wi-Fi Wireless City infrastructures are originally designed for Internet data services. Therefore, voice transmission such as real time or substantial real time transmission was not of primary concern. Therefore, quality of service (QoS) problems exists in the infrastructure in using VoIP IP Phone for voice service in infrastructure systems. As can be seen, it is desirous to have an improved Wi-Fi Wireless City infrastructure that can improve upon the quality of service including sound quality of a VoIP IP Phone associated with the Wi-Fi Wireless City infrastructure in additional to rely only on the limited 802.11 QoS capability.

### SUMMARY OF THE INVENTION

In our invention, a separate VoIP network is provided which only takes care of VoIP voice data. The hot spot network is provided that takes care of Internet data. Then both data packages (Internet data and Voice data) are then transmitted through either hot spot network backbone or WiMax backbone with priority setting for voice information, (Voice data has higher priority than Internet data). Because the whole network combines two networks through special arrangements, a hybrid network is achieved.

In the present invention, substantially separate and distinct paths for voice and data are provided within a Wi-Fi Network.

In the present invention, a separate VoIP network which only take care of VoIP voice data, and a hot spot network that takes care of Internet data are separately provided for processing within a hybrid VoIP/WiFi network. In the hybrid VoIP/WiFi network, voice data has higher priority than Internet data.

Within the provided Wi-Fi Network, the voice packet and data packet are kept in substantially different paths within the Network.

A hybrid system is provided that includes two subsystems. They are a regular Internet data system for data services and a special Wi-Fi VoIP network of the present invention for voice service. Within the hybrid system, these two subsystems are combined together through a special arrangement and QoS control to substantially separate these two services thereby providing the best quality of service. By using this invention as at least part of a Wi-Fi Wireless City infrastructure, good quality services are provided in both Internet Data and VoIP voice services.

A device adapted to process either voice, or data information and being associated with a Wi-Fi network is provided. The device includes a determinator for determining whether the processed information is data information or voice information; a data path for transmitting data information to or from a data terminal associated with the WiFi network; and a voice path for transmitting voice information to or from a voice terminal associated with the WiFi network, with voice information having transmission priority over data information, and voice path substantially independent of the data path.

A hybrid WiFi communication system adapted to process either voice or data information is provided. The system comprises determinator for determining whether the processed information is data information or voice information; a data path for transmitting data information to or from a data terminal associated with the WiFi network; and a voice path for transmitting voice information to or from a voice terminal associated with the WiFi network, with voice information having transmission priority over data information, and voice path substantially independent of the data path.

A method for processing information associated with a Wi-Fi network is provided. The method comprising the steps of: determining whether the processed information is data information or voice information; providing a data path for transmitting data information to or from a data terminal associated with the WiFi network; and providing a voice path for transmitting voice information to or from a voice terminal associated with the WiFi network, with voice information having transmission priority over data information, and voice path substantially independent of the data path.

### BRIEF DESCRIPTION OF THE DRAWING

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a system overview in accordance with some embodiments of the invention.

FIG. 2 is an example of a hybrid network in accordance with some embodiments of the invention.

FIG. 3 is an example of the hybrid network for wireless city application in accordance with some embodiments of the invention.

FIG. 3A is an example of a mesh WiFi network in accordance with some embodiments of the invention.

FIG. 4 is an example of a first system block diagram in accordance with some embodiments of the invention.

FIG. 5 is an example of a second system block diagram in accordance with some embodiments of the invention.

FIG. 6 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to substantially separate and distinct paths for voice information and data information being provided within a Wi-Fi Network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of substantially separate and distinct paths for voice and data within a Wi-Fi Network described herein. The non-processor circuits may include, but are not limited to, a radio receiver, a radio transmitter, signal drivers, clock circuits, power source circuits, and user input devices. As such, these functions may be interpreted as steps of a method to perform the functions of substantially separate and distinct paths for voice and data within a Wi-Fi Network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Current Wi-Fi Wireless City infrastructure is originally designed for Internet Data service. Wi-Fi VoIP IP Phone for voice service has significant QoS problem on current infrastructure. Because the requirements for Internet data service and VoIP voice service are different and compete against at each other and because Wi-Fi 802.11 technology including 802.11e can't provide sufficient QoS to separate these two services, a major quality problems exist for current Wi-Fi Wireless City operation to provide VoIP voice service.

To solve the QoS problem for simultaneously providing both Internet Data and VoIP voice services, the present invention proposes a hybrid system. This hybrid system consists a regular Wi-Fi Internet data network and a special network called Wi-Fi VoIP Network of the present invention. The regular Wi-Fi Internet data network can be Mesh Wi-Fi Hot Spot Network or other network which can provide good Internet Data service. The Wi-Fi VoIP Network of the present invention is specially designed to provide the required QoS to protect VoIP voice from Internet data interference such that the hybrid system of the present invention can simultaneously provide good quality data and voice services.

In other words, we propose a separate VoIP network which only takes care of VoIP voice data. The existing hot spot network will take care of Internet data. Then both data packages (i.e. Internet data and Voice data packages or packets) are then be transmitted through either hot spot network backbone or WiMax backbone with priority setting, (with voice data or information having higher priority than Internet data). Because the whole network combines two networks through special arrangement, we call this is a hybrid network.

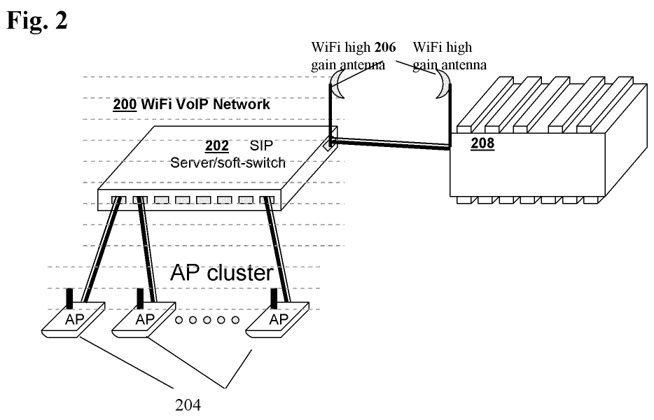

It should be noted that in the following figure, especially FIG. 2, a Wi-Fi VoIP Network is provided. This network consists of Wi-Fi access a point (AP) Cluster and a Session Initiation Protocol (SIP) server/soft-switch.

In the instant patent application, the existing problems are solved by the creation of a hybrid system which comprises voice subsystem and a data subsystem. Data subsystem is used for WiFi Internet Data service typically used in regular mesh WiFi network. Voice subsystem is providing for use by a WiFi VoIP voice subsystem. This voice subsystem comprises substantially of the WiFi VoIP network of the present invention.

The two subsystem are separated using service identifiers or IDs (including IDs for both data or voice). Therefore, when an end-user tries to register to the network, the IDs are identified. The voice packets are given priority.

An exemplified system works as follows. A Mesh WiFi network provides following two functions: firstly, Internet data service with roaming, mobility, and area coverage capability; and secondly a back-bone infrastructure which provides roaming, mobility and area coverage for the WiFi VoIP network of the present invention. The WiFi VoIP network of the present invention provides micro-cell hot spot coverage for VoIP IP phone voice service. Furthermore, the WiFi VoIP network of the present invention only provides limited hand-over function. The hybrid system rely on the mesh WiFi network for roaming, mobility and area overage. When VoIP voice data package is transmitting in mesh WiFi network, this voice data package shall have high priority over regular Internet data package in order to insure that real time requirements for voice communication are met.

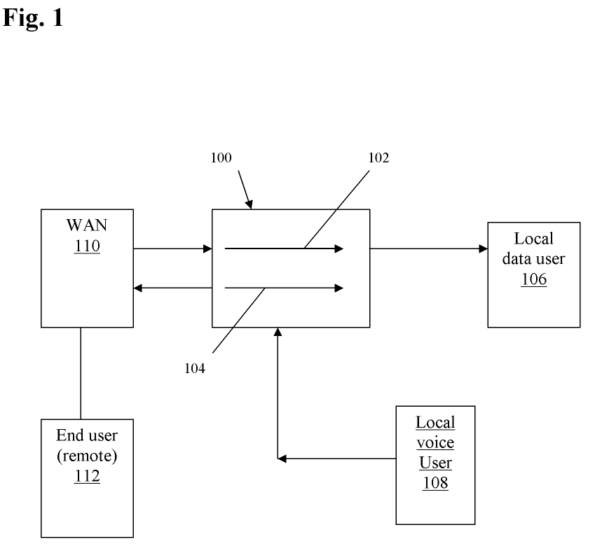

Referring to FIG. 1, a system diagram of the present invention is shown. A hybrid WiFi/VoIP network 100 having substantially independent data path 102 and voice path 104 is provided. Hybrid WiFi/VoIP network 100 is coupled to local users including at least one local data user 106 and at least one local voice user 108. Local data user 106 may be a user who is using hybrid WiFi/VoIP network 100 to surf the Internet. Local voice user 108 may be a user using VoIP for voice communication under hybrid WiFi/VoIP network 100. Hybrid WiFi/VoIP network 100 is adapted to give priority to local voice user 108 via voice path 104 of hybrid WiFi/VoIP network 100 due to such factors as real time communication requirements of voice communications. Hybrid WiFi/VoIP network 100, in turn, is signally coupled to wide area network (WAN) 110. Wide area network (WAN) 110 is the means for coupling at least one remote end user 1 12 for data or voice communication with local data user 106 or local voice user 108.

Referring to FIG. 2, an exemplified WiFi over VoIP network 200 comprises server/soft switch 202 of the present invention is provided. Exemplified WiFi over VoIP network 200 comprises server/soft switch 202 and a plurality of access points 204 (a single access point may be conceivable). A cluster of at least one access point 204 is signally coupled to server/soft switch 202. Server/soft switch 202 further has a WiFi high gain antenna 206 for wirelessly communicating with a WiFi high gain antenna 206 on WiFi router 208 (or cable to connect coupling server/soft switch 202 and WiFi router 208). The device used in the Wi-Fi AP Cluster can be as simple as a regular Wi-Fi Access Point with minor software update or complicated as a base station with heavy QoS and multi-capability. The coupling between server/soft switch 202 and access point 204 may be cable. The coupling server/soft switch 202 and WiFi router 208 may also be cable or, alternatively WiFi high gain antenna 206.

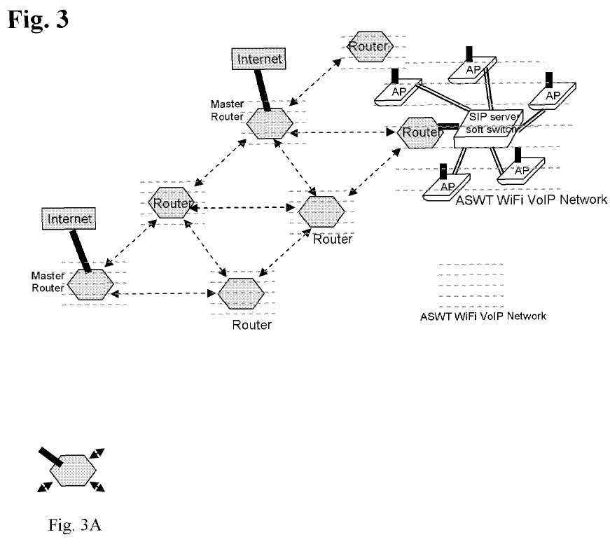

Referring to FIG. 3A, a WiFi router 208 unit is depicted. The WiFi router 208 shown has couplings for signally coupling with other devices. The couplings include one coupling with wide area network (WAN) 10 and several coupling between routers 300.

Referring to FIG. 3, a plurality of WiFi router 208 is connected to other WiFi routers 208. Each WiFi router 208 has one coupling with wide area network (WAN) 110. Each WiFi router 208 is adapted to be coupled with an exemplified WiFi over VoIP network 200 (only one shown).

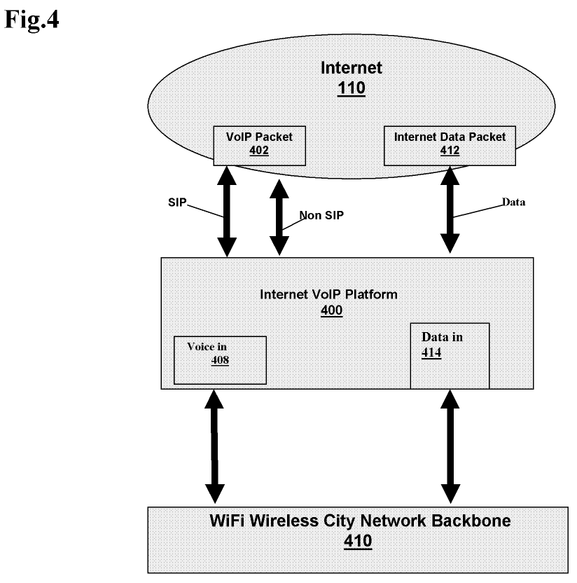

Referring to FIG. 4, a first embodiment of the present invention is shown. A Internet VoIP platform 400 of the present invention is signally and bi-directionally coupled to 110 WAN. Internet VoIP platform 400 is used for determining the characteristics of packets processed therein. Voice packets 402 are given priority over data packet 412. Furthermore, Internet VoIP platform 400 functions as a headquarter server for billing, multimedia service and other business activities in addition to the VoIP activity. The signally couplings include coupling with data packet 412 and/or voice packet 402. Voice packet is typically a VoIP packet, which comprises two subcategories, firstly SIP packets 404 and secondly non-SIP packets 406 both of which form voice packet 402. Internet VoIP platform 400 further process non-SIP packet 406 and SIP packet 404 and then combine both into block 408 ( This process is subjected to another invention which will be filed). Via voice in block 408 Internet VoIP platform 400 is signally coupled to WiFi network backbone 410 for transmitting processed voice packet 402 for voice communications.

For data information, data packet 412 of Internet 10 is transmitted to and from Internet VoIP platform 400 via data in block 414 and than coupled to WiFi network backbone 410. In the process, data packet 412 gives priority toward voice packet 402 by means of the functions of Internet VoIP platform 400 for such considerations as real time voice communication meeting a predetermined communication quality, etc.

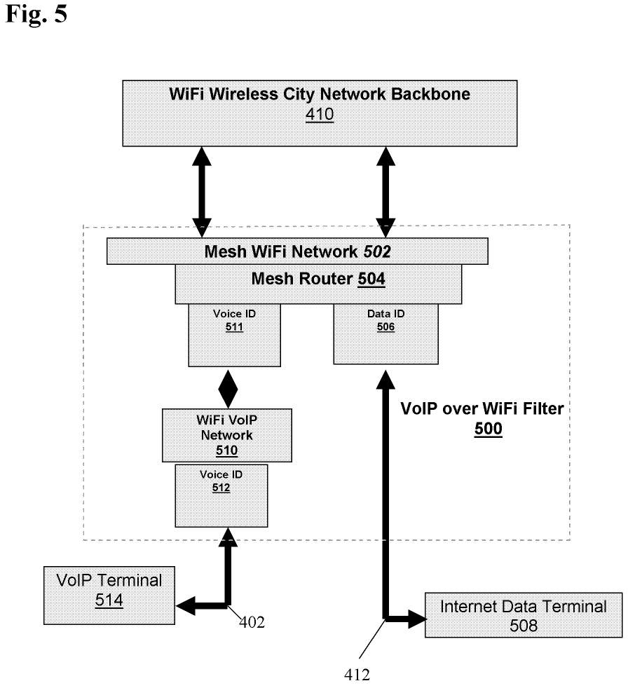

Referring to FIG. 5, a second embodiment of the present invention is shown. A VoIP over WiFi filter 500 for filtering both voice packet 402 and data packet 412 is provided. VoIP over WiFi filter 500 comprise a data identifier 506 and a voice identifier 512 for identifying data packet 412 and voice packet 402 that passes through VoIP over WiFi filter 500. VoIP over WiFi filter 500 further comprises a mesh WiFi network layer 502 and mesh router layer 504. The mesh WiFi network 502 and mesh router 504 are both adapted to function similarly as described in FIGS. 3-3A of the present invention. In addition, VoIP over WiFi filter 500 comprises a voice subset or path. The subset comprises a voice identifier 511 which identifies voice packet 402 by unpacketing each packet and determine a nature of the packet for passing the voice packet, and a WiFi VoIP network 510 which is shown and defined in FIG. 2 for processing voice packet 402. The subset also comprises a voice identifier 512 which connects WiFi VoIP network 510 and VoIP Terminal 514. An outside voice terminal 514 is signally coupled to VoIP over WiFi filter 500 via the 512 therein. The subset further includes mesh WiFi network 502 and mesh router 504 commonly shared with the data path. In other words, a voice path is created within VoIP over WiFi filter 500, wherein the voice packet 402 is first identified by voice identifier 512 and processed by WiFi VoIP network 510 and passes through the commonly shared mesh WiFi network 502 and mesh router 504. VoIP over WiFi filter 500 is coupled to WiFi network backbone 410 via mesh WiFi network 502 therein. Internet data terminal 508 is signally coupled to data identifier 506 of VoIP over WiFi filter 500 for transmitting data to and from VoIP over WiFi filter 500. Internet data terminal 508 may include a PC having wireless coupling. As shown in FIG. 3, Internet data packet 412 has its own path in WiFi Filter 500 and is not signally coupled into WiFi VoIP Network 510. Furthermore, Internet data packet 412 passes through the mesh WiFi network 502 and mesh router 504 from or to WiFi network backbone 410.

As shown in FIG. 2, voice data packet 402 is wirelessly coupled to AP cluster of Voice ID 512 and WiFi network 510 and then either wire-couple or wireless-couple by high gain antenna to mesh router 504. This voice path is different from the data path as shown in FIGS. 3 & 3A. FIGS. 3-3A show that the data packet 412 is wirelessly coupled to the mesh router 504. Therefore, two paths are independent at mesh router 504 level and don't compete with each other to create QoS problems.

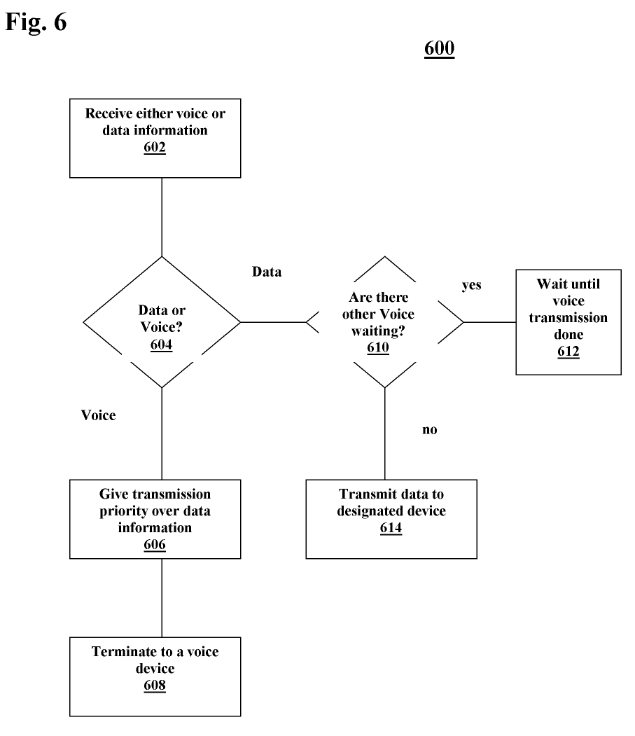

Referring to FIG. 6, a flowchart 600 is shown. Data information and voice information are both received (Step 602). A determination is made as to whether the information is voice information or data information (Step 604). Voice information is given transmission priority over data information and transmitted (Step 606). In turn, the voice information is terminated to a voice device. If the information is data information, a second determination is made as to whether there are other voice information waiting to be transmitted (Step 610). If there are voice information waiting, data information waits until the voice information transmission is done (Step 612). If there are no voice information waiting, data information will transmit data to the designated data device (Step 614). Quality of Service (QoS) in the present invention is related to packet-switched networks or computer networking, wherein the probability of the telecommunication network meets a predetermined traffic requirement.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A device adapted to process either voice or data information and being associated with a Wi-Fi network, the device comprising:
a determinator for determining whether the processed information is data information or voice information;
a data path for transmitting data information to or from a data terminal associated with the WiFi network; and
a voice path for transmitting voice information to or from a voice terminal associated with the WiFi network, with voice information having transmission priority over data information, and voice path substantially independent of the data path.

2. The device of claim 1, said Wi-Fi network comprises a Wi-Fi mesh having at least one access point (AP).

3. The device of claim 1, wherein voice information comprises VoIP packets.

4. The device of claim 1, wherein the determinator determines whether the processed information is data information or voice information by unpacketing a packet.

5. The device of claim 1, wherein the determinator comprises a voice identifier.

6. The device of claim 1, wherein the data information comprises data packets being wirelessly coupled to a mesh router, thereby the voice path and the data path are independent at a mesh router level.

7. The device of claim 1, wherein voice information comprises packets.

8. A hybrid WiFi communication system adapted to process either voice or data information, the system comprising:
determinator for determining whether the processed information is data information or voice information;
a data path for transmitting data information to or from a data terminal associated with the WiFi network; and
a voice path for transmitting voice information to or from a voice terminal associated with the WiFi network, with voice information having transmission priority over data information, and voice path substantially independent of the data path.

9. The communication system of claim 8, said Wi-Fi network comprises a Wi-Fi mesh having at least one access point (AP).

10. The communication system of claim 8, wherein voice information comprises VoIP packets.

11. The communication system of claim 8, wherein the determinator determines whether the processed information is data information or voice information by unpacketing a packet.

12. The communication system of claim 8, wherein the determinator comprises a voice identifier.

13. The communication system of claim 8, wherein the data information comprises data packets being wirelessly coupled to a mesh router, thereby the voice path and the data path are independent at a mesh router level.

14. The communication system of claim 8, wherein voice information comprises packets

15. A method for processing information associated with a Wi-Fi network, the method comprising the steps of:
determining whether the processed information is data information or voice information;
providing a data path for transmitting data information to or from a data terminal associated with the WiFi network; and
providing a voice path for transmitting voice information to or from a voice terminal associated with the WiFi network, with voice information having transmission priority over data information, and voice path substantially independent of the data path.

16. The method of claim 15, said Wi-Fi network comprises a Wi-Fi mesh having at least one access point (AP).

17. The method of claim 15, wherein voice information comprises VoIP packets.

18. The method of claim 15, wherein the determinator determines whether the processed information is data information or voice information by unpacketing a packet.

19. The method of claim 15, wherein the determinator comprises a voice identifier.

20. The method of claim 15, wherein the data information comprises data packets being wirelessly coupled to a mesh router, thereby the voice path and the data path are independent at a mesh router level.

21. The method of claim 15, wherein voice information comprises packets.
